(19) United States
(12) Patent Application Publication
(10) Pub. No.: US 2017/0042359 A1
(43) Pub. Date: Feb. 16, 2017

(54) Clad Cookware

(71) Applicant: Lee Lisheng Huang, Palo Alto, CA (US)

(72) Inventor: Lee Lisheng Huang, Palo Alto, CA (US)

(21) Appl. No.: 15/306,086

(22) PCT Filed: Apr. 29, 2014
(86) PCT No.: PCT/US14/35763

§ 371 Date: Oct. 22, 2016

(51) Int. Cl. A47J 27/022; A47J 36/02; A47J 27/00

(52) U.S. Cl. CPC A47J 27/022; A47J 27/002; A47J 36/02

(57) ABSTRACT

A novel cookware made of clad composite materials provides novel functionalities not only for improvement in daily use, but also provides a practical way to incorporate fm structures on the surface of the clad materials.

### FIELD OF THE INVENTION

The following disclosure relates to the manufacture of energy efficient cookware. More particularly, the present invention teaches a variety of manufacturing methods for cookware that efficiently transfers thermal energy from a heating element to a cooking surface.

### BACKGROUND

Cookware is used to hold and apply heat to food. Exemplary pieces of cookware include a stock pot, a wok, and a frying pan. Although each of these have different shapes, they each include two basic elements: one surface for receiving thermal energy from a heat source, a “heat-receiving surface,” and one surface for applying the heat to food, a “cooking surface.”

Thermal energy can be generated from many different sources. Examples include electric and gas ranges. A heat source can generate the thermal energy by, e.g. burning gas, or electricity running through a heating coil. When cooking food, the piece of cookware transfers thermal energy from the heat source to a heat-receiving surface. The food in the cookware then absorbs heat from the cooking surface, cooking the food.

Thermal energy transfer from combustion sources can be inefficient. For example, a gas range is reported to be only about 30% efficient. This means that a lot of energy is wasted when cooking. The inefficiency increases energy bills and produces unnecessary, undesirable CO₂ which is released into the environment.

There are some prior efforts directed towards improving the efficiency of cookware, such as patent U.S. Pat. No. 8,037,602 B2, patent application Ser. No. 12/723,605. With the new designs, improvement in efficiency is achieved with new cookware cooking on gas stoves. However, the cost of the efficient cookware is still higher than conventional cookware. There is still need for further reduction of the cost of the energy efficient cookware for wider applications.

### SUMMARY OF THE INVENTION

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

In U.S. Pat. No. 8,037,602 B2, the current inventor suggests a novel cookware with a heat sink on the base of the cookware, and a manufacture process to produce it. That method applied is suitable for making stainless steel cookware, but still challenging to apply on an aluminum cookware. It is the goal of the current invention to provide a way to incorporate fins on an aluminum cookware.

It is another aspect of the current invention to provide a clad cookware where the outer layer of the cookware is clad with solder material which is capable of attaching fins on the outer surface of the cookware cost effectively. It is another aspect of the current invention to provide a fin pattern that is easy to fabricate and braze onto the clad cookware.

### BRIEF DESCRIPTION OF THE FIGURES

Objectives and advantages disclosed herein will be understood by reading the following detailed description in conjunction with the drawing, in which:

FIG. 1 Clad Aluminum Cookware.

FIG. 2 Clad Aluminum Cookware with fins.

### DETAILED DESCRIPTION

Although the following detailed description contains many specifics for the purpose of illustration, anyone of ordinary skill in the art will readily appreciate that many variations and alterations to the following exemplary details may be made. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

In a typical process for cooking food, a piece of cookware holding a medium, such as water, is placed on a gas range having a burner. When ignited, the burner produces a flame that rises up in response to pressure of the gas in the range's supply piping. The buoyancy of the hot air causes the flame to touch the cookware base of the cookware. Thermal energy is transferred from the flame to the cookware base via convection as well as thermal radiation. One side of the cookware base, the heat-receiving surface, absorbs the thermal energy. In the cookware base thermal conduction transfers this thermal energy to the cooking side of the cookware base. The cooking side of the cookware base then transfers thermal energy to the medium (e.g. water or food) via conduction and convection. Typically the heat transfer from the fluid, i.e. the air flow, to solid is not efficient due to small convection heat transfer coefficients. Such an issue also affects the heat transfer inside a convection oven where hot air is circulated inside the oven, and inside an impingement oven where the hot air is jetted towards the cookware. To improve that, fins are incorporated on cookware to increase the surface area for more efficient heat transfer. US. Pat. No. 8,037,602 B2 discloses designs with suitable fins dimensions for cookware application. Also disclosed is a method for creating fins by making a thick base cookware and then creating fins on the thick base. This method is quite suitable for stainless cookware where an aluminum base can be impact bonded onto it. However it has

One way to attach fins to the cookware is to braze fins on the base of the cookware. A typical process of brazing or soldering fins to the cookware is to prepare fins, apply filler or solder material on the base of the cookware, to place the fins on the base of the cookware with help of a fixture and finally, put the assembly in a high temperature oven or bath to raise the temperature of the assembly above the melting point of the filler/solder to bond the fins to the cookware. In the process, flux is applied to reduce oxidation of the materials at high temperatures.

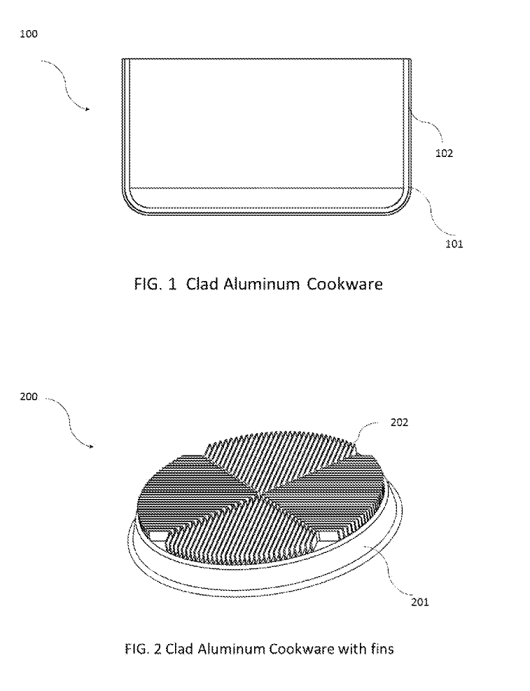

Uniform application of the filler material is critical for the quality of the bonding. An insufficient amount of material will result in weak bonding, affecting the heat transfer from the fins to the cookware. To ensure the quality of the bonding, it is proposed to use clad material to make the cookware, i.e. the solder material is formed on the wall of the cookware. Such a cookware structure eliminates the messy process of applying solder/filler material, making the soldering process much more robust. For example, FIG. 1 shows an aluminum cookware made from clad materials. The cookware 100 has wall, base, and two handles on the wall of the cookware. The wall and base of the cookware consist of two layers of materials 101 and 102, where 101 in this example is aluminum alloy 3003 while the second layer is aluminum alloy 4043. Aluminum alloys 3003 and 3004 are typically used for cookware because of their mechanical strength and resistance to atmospheric corrosion. Aluminum 4043 has a lower melting point, and is therefore typically used as filler or solder material in aluminum brazing processes. The clad material can be formed by either the cold rolling or hot rolling processes. The clad material typically can be designed such that 90% of the thickness is the base material such as Al alloy 3003 and the 10% of the thickness is Al 4043, or Al 4045. The filler material is preferred to be thicker than 10 micrometers.

The aluminum alloy 3003 side of this clad material set can further be roll bonded to another layer of Al 1000 series alloy which is then bonded to a layer of stainless steel to serve as the food surface of the cookware. The reason for further bonding to stainless steel is its desirability for serving as a side surface of a cookware.

The solder aluminum material typically has a higher Si concentration, and as a result its hardness is higher than that of pure aluminum or aluminum 3003 alloys. For example, Aluminum alloy 4043 has hardness of 39 on the Brisnel hardness scale while Aluminum 3003 is 28. A harder outer surface will provide extra protection in normal cookware applications. This clad aluminum cookware can be used as drawn with improved mechanical hardness.

More importantly, aluminum alloy 4043 has lower melting temperature than aluminum alloy 3003, so it is possible to melt the Al alloy 4043 to bond with an aluminum heat exchanger structure based on aluminum 3003 to the outside surface of the cookware. The heat exchanger such as an array of fins can substantially improve the thermal efficiency on a gas cook stove.

One example of such a heat exchanger is shown in FIG. 2 where a cookware 201 is made of clad aluminum materials. The composite is Al 3003 and Al 4043 aluminum combination. An array structure of fins 202 is placed on the bottom of the cookware 201. The fins are made from aluminum 3003 as well. The fins are permanently attached to the cookware by putting the assembly in a brazing oven to heat up the temperature to the temperature at which Al 4043 on the bottom of the pan melts to form bonds between the pan and the fins. During the heating process, brazing flux needs to be applied to clean the surface oxides existing on the materials to allow a high quality bond. Also it is desirable that the process is done in an oxygen depleted atmosphere to reduce oxidation of the aluminum at high temperatures.

In FIG. 2, the fin pattern is an array of right angled fins, arranged in quarters. This pattern is a preferred pattern to be used on the cookware. The fins have uniform density therefore uniformly increasing the surface area over the cookware base, effectively improving the heat transfer. Another possible fin pattern is the linear one we proposed in our previous pattern. The linear one is suitable for the manufacturing process patented in U.S. Pat. No. 8,037,602 B2, is actually a subset of parallel line patterns which can include different line shapes: sine wave, zigzag, arcs etc. However these are perceived to be difficult to clean. Another fin pattern that gives a uniform fin density is concentric rings. However the restricted flame flow in the concentric ring pattern compromises improvement of heat transfer efficiency, and it is more difficult to clean. Yet another high density fin arrangement is a serpentine pattern, which is perceived to be difficult to clean. Therefore the quadruple group of right angle bend fin pattern is a preferred fin pattern, i.e. the angle formed by the fin bend angle is 90 degrees, as shown in FIG. 2. An alternative is a triplet group, where the fin bend angle is 120 degrees. Other configurations, with more groups and lower bend angles, are also possible, where the bend angle is 360 degrees divided by the number of groups. In case of FIG. 2. The number of groups is 4, therefore the bend angle of the fins is 90 degrees.

The inside of the cookware can be further coated with non-stick coating material such as Teflon or ceramic non-stick coatings, or the cookware can be anodized either by second type and third type anodizing processes.

The cookware can also be a stainless steel cookware. The clad material system can consist of a layer of stainless steel and a layer of the aluminum. The advantage of having an aluminum is to provide even heating on the cookware base. In the current proposal the aluminum used in this clad composite is a clad alloy of Al 3003 and Al 4043 or a clad alloy of Al 3004 and Al 4045. The function of this aluminum layer is to provide uniform heating on the base, and also to provide a bonding material to bond aluminum fins, which is typically aluminum alloys 3003 and 3004 to the cookware.

Besides bonding aluminum fin structures to stainless cookware, the outer layer can be filler material that bonds stainless steel fins to a stainless steel cookware. The cookware can be clad with a thin layer of silver copper indium nickel, silver copper cadmium zinc, silver copper zinc, or silver copper cadmium zinc nickel composites. Such compounds can be used to braze stainless steel fins on the base of a stainless steel cookware. Further, similar silver based cladding materials on the outer layer can also be the filler material for brazing copper fins to the base of either copper, aluminum, or stainless steel cookware.

For boiling water applications, fins can also be incorporated inside the cookware to improve the heat transfer to the water. In this case it is also preferable to have a clad cookware where the inside surface is a solder material such as aluminum 4043 for aluminum clad cookware.

Therefore in general, the cladding materials for a cookware can be formed in combinations and permutations of materials such as stainless steel, copper and aluminum, with the filler material as outer surface layers suitable to bond fin structures formed by materials such as stainless steel, copper, and aluminum.

It will be appreciated to those skilled in the art that the preceding examples and are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

What is claimed is:

1. A process of making heat exchanger on a cookware comprising Providing a cookware made of a clad material with a solder layer;
Preparing exchange fins;
Assembling the fins in a pattern on the solder surface of the cookware;
Applying flux;
Heating the assembly to high temperatures in a controlled atmospheric environment.

2. A process of claim 1 wherein the clad material comprises an aluminum layer.

3. A process of claim 1 wherein the clad material comprises a stainless layer.

4. A process of claim 1 wherein the clad material comprises a copper layer.

5. A process of claim 1, wherein the fin pattern is a serpentine pattern.

6. A process of claim 1, wherein the fin pattern is a parallel line pattern.

7. A process of claim 1, wherein the fin pattern is a central symmetric pattern consisting of number N of subgroups of fins where the parallel fins are bent to an angle of 360 degrees divided by N.

8. A cookware made of a clad material comprising a layer of metal and a layer of metal alloy which may serve as a solder material to further bond a heat exchanger structure on the cookware.

9. A cookware of claim 8, wherein the clad material consists of a base layer of aluminum 300× alloy and a solder layer of aluminum 304× alloy.

10. A cookware of claim 8, wherein the clad material comprises a stainless steel layer.

11. A cookware of claim 8, wherein the clad material comprises a copper layer.
